(19) United States
(12) Patent Application Publication
(10) Pub. No.: US 2016/0367954 A1
(43) Pub. Date: Dec. 22, 2016

(54) CONDITION MONITORING SYSTEM AND METHOD FOR HOMOGENIZERS

(71) Applicant: TETRA LAVAL HOLDINGS & FINANCE S.A., Pully (CH)

(72) Inventor: Pontus AVERGÅRD, Malmö (SE)

(73) Assignee: Tetra Laval Holdings & Finance S.A., Pully (CH)

(21) Appl. No.: 14/902,370

(22) PCT Filed: Jun. 26, 2014
(86) PCT No.: PCT/EP2014/063529

§ 371 Date: Dec. 31, 2015

(30) Foreign Application Priority Data
Jul. 3, 2013 (SE) 1350829-6

(51) Int. Cl. B01F 15/00; B01F 13/04

(52) U.S. Cl. CPC B01F 15/00129; B01F 15/00162; B01F 13/045; B01F 15/00201; B01F 15/00175

(57) ABSTRACT

A method and a system for condition monitoring of a homogenizer are provided. After receiving a first pressure data from a first pressure sensor indicating a product pressure upstream a homogenizing device, and a second pressure data from a second pressure sensor indicating a counter pressure used for holding a forcer in said homogenizing device in position, these can be compared with a first pressure reference data and a second pressure reference data associated a properly working homogenizer such that the condition of the homogenizer can be determined.

### TECHNICAL FIELD

The invention generally relates to the field of condition monitoring, also referred to as inline diagnosis. More particularly, it refers to condition monitoring systems and methods for homogenizers.

### BACKGROUND OF THE INVENTION

In order for companies within the food processing industry to stay competitive it is of uttermost importance to make sure that the food processing equipment is working properly and that the downtime due to equipment failures are kept at a minimum level. In order to achieve this most companies regularly service their equipment in order to make sure that the risk of equipment failures is kept low.

However, a potential downside of servicing the equipment frequently, more particularly replacing wear parts, in order to reduce the risk of downtime due to equipment failure, is that the wear parts, e.g. valves or bearings, are replaced earlier than needed, thus increasing the spare parts cost. In many cases an increased spare parts cost can be justified by the reduced risk of downtime caused by equipment failure, but still many wear parts are replaced too early with the effect of increased cost and unnecessary environmental impact.

In order to make sure that parts are replaced at the right time so-called condition monitoring systems have been used in different fields. Within the field of liquid food processing, condition monitoring systems based on vibration analysis have been used in order to detect when a centrifugal separator is not working properly due to e.g. a worn out bearing.

For pumps, particularly high pressure pumps generating a pressure of 10-25 MPa (100-250 bar), and homogenizers comprising such high pressure pumps there is a need to be able to monitor the condition in a cost efficient and reliable manner. Further, apart from being able to monitor the condition, there is also a need to have methods and systems for determining the condition based on information gathered via different sensors.

### SUMMARY

Accordingly, the present invention preferably seeks to mitigate, alleviate or eliminate one or more of the above-identified deficiencies in the art and disadvantages singly or in any combination and solves at least the above mentioned problems by providing below mentioned aspects.

According to a first aspect it is provided a method for condition monitoring of a homogenizer, said method comprising receiving first pressure data from a first pressure sensor, said first pressure data indicating a product pressure upstream a homogenizing device, and comparing said first pressure data with a first pressure reference data.

The method may further comprise receiving second pressure data from a second pressure sensor, said second pressure data indicating a counter pressure used for holding a forcer in said homogenizing device in position, comparing said first pressure data and said second pressure data with a first pressure reference data and a second pressure reference data.

The second pressure data may be related to a hydraulic pressure formed by a hydraulic pump.

The step of comparing said first pressure data and said second pressure data with a first pressure reference data and a second pressure reference data, further comprising determining a pressure ratio between said first pressure data and said second pressure data, determining a deviation ratio between said pressure ratio and a pressure reference ratio, being a ratio between said first pressure reference data and said second pressure reference data.

The method may further comprise sending a notification signal indicating non-optimal conditions if said deviation ratio is less than 0.85.

The method may further comprise sending a notification signal indicating non-optimal conditions if said deviation ratio is greater than 1.15.

The method may further comprise receiving a third pressure data from a third pressure sensor, said third pressure data indicating an additional product pressure downstream said homogenizing device and upstream an additional homogenizing device, wherein said step of comparing said first pressure data with said first pressure reference data, further comprises comparing said third pressure data with a third pressure reference data.

The method may further comprise receiving a fourth pressure data from a fourth pressure sensor, said fourth pressure data indicating a counter pressure used for holding an additional forcer in an additional homogenizing device in position, and wherein said step of comparing said first pressure data with said first pressure reference data, further comprises comparing said fourth pressure data with a fourth pressure reference data.

The method may further comprise receiving an eccentric shaft position data from a position sensor, and wherein said step of comparing said first pressure data and said second pressure data with said first pressure reference data and said second pressure reference data, further comprises taking into account said eccentric shaft position in order to provide for that differences depending on the eccentric shaft position are compensated for.

The method may further comprise receiving a running time data indicating running time since latest stop, wherein said step of comparing said first pressure data and said second pressure data with said first pressure reference data and said second pressure reference data, further comprises taking into account said running time data in order to provide for that differences depending on said running time since latest stop are compensated for.

The method may further comprise receiving a temperature data indicating a temperature of said homogenizer, wherein said step of comparing said first pressure data with said first pressure reference data, further comprises taking into account said temperature data in order to provide for that differences depending on said temperature of said homogenizer are compensated for.

The step of comparing said first pressure data with a first pressure reference data may comprise determining a variance for said first pressure data, and comparing said variance for said first pressure data with a variance for said first pressure reference data.

According to a second aspect it is provided a system for condition monitoring of a homogenizer, said system comprising a first pressure sensor for capturing a first pressure data, said first pressure data indicating a product pressure upstream a homogenizing device, and a data handling apparatus for comparing said first pressure data with a first pressure reference data.

The system may further comprise a second pressure sensor for capturing a second pressure data, said second pressure data indicating a counter pressure used for holding a forcer in said homogenizing device in position, and said data handling apparatus being configured to compare said first pressure data and said second pressure data with a first pressure reference data and said second pressure reference data.

The system may further comprise a third pressure sensor for capturing a third pressure data indicating an additional product pressure downstream said homogenizing device and upstream an additional homogenizing device, and said data handling apparatus being configured to compare said third pressure data with a third pressure reference data.

The system may further comprise a fourth pressure sensor for capturing a fourth pressure data indicating a counter pressure used for holding an additional forcer in an additional homogenizing device in position, and said data handling apparatus being configured to compare said third pressure data and said fourth pressure data with a third pressure reference data and a fourth pressure reference data.

The system may further comprise a position sensor for determining an eccentric shaft position, and said data handling apparatus being configured to take said eccentric shaft position into account when comparing said first pressure data with said first pressure reference data.

According to a third aspect it is provided a computer program comprising computer program code adapted to perform the first aspect when said computer program is run on a computer.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates a homogenizer, more particularly a homogenizer marketed by Tetra Pak.

FIG. 2 illustrates a first and a second homogenizing device.

FIG. 3 illustrates part of the homogenizer having a first pressure sensor.

FIG. 4 illustrates a hydraulic pump used for forming a counter pressure.

### DETAILED DESCRIPTION OF PREFERRED EMBODIMENTS

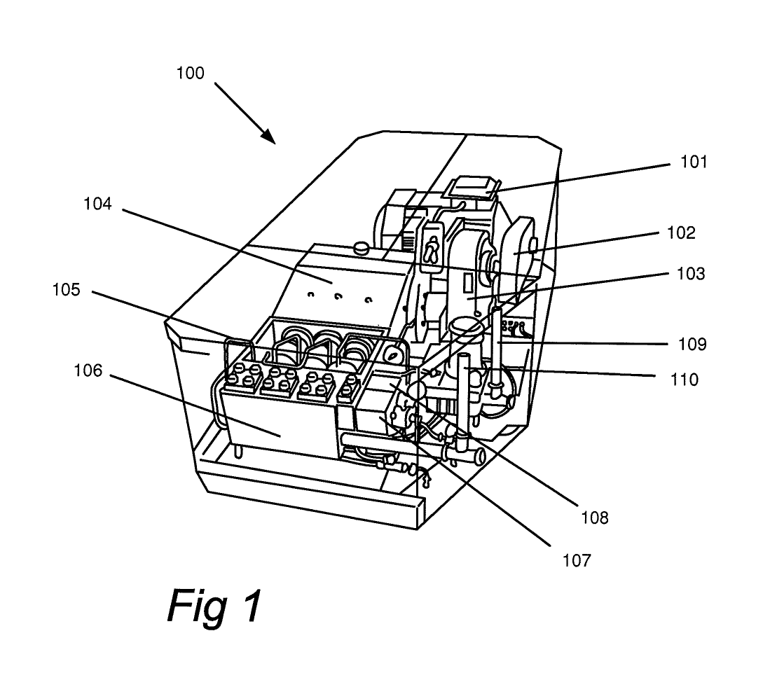

FIG. 1 generally illustrates a homogenizer 100, more particularly a homogenizer sold under the name Tetra Alex™ by Tetra Pak. Generally, the homogenizer 100 comprises two main parts, a high pressure pump and a homgenising device. The high pressure pump forms a high pressure and the homogenising device provides one or several gaps through which the product is forced with the effect that smaller fat globules are formed. Further effects of homogenization is more appetizing colour, reduced sensitivity to fat oxidation, more full-bodied flavour and better stability of cultured milk products.

In this example, the high pressure pump is a piston pump driven by a main drive motor 101 connected via a belt transmission 102 and a gearbox 103 to a crankshaft placed in a crankcase 104. By using the crankshaft the rotary motion is converted to a reciprocating motion driving pump pistons 105 back and forth. Today, it is common to have three to five pump pistons.

The pump pistons 105 run in cavities formed in a pump block 106 made to withstand the high pressure created by the pump pistons. Today it is common to increase the pressure from 300 kPa (3 bar) to about 10-25 MPa (100-250 bar), but higher pressures can be used as well.

Through cavities in the pump block 106 the product enters a first homogenizing device 107 and thereafter, in many cases, a second homogenizing device 108. As described above, by forcing the product through one or several gaps the properties of the product can be changed.

The reciprocating motion of the pump pistons 105 creates pulsations. To reduce the pulsations it is common practice today to place an inlet damper 109 on an inlet of the homogenizer. Further, in order to reduce vibrations and noise it is common practice to place an outlet damper 110 on an outlet.

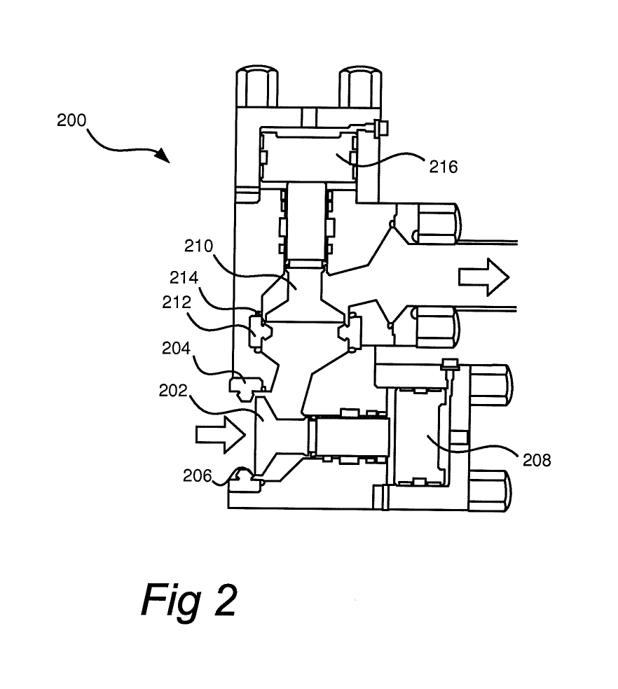

FIG. 2 illustrates an example of a two-stage homogenizer having a first homogenizing device placed in a lower section and a second homogenizing device placed in an upper section.

The first homogenizing device comprises a first stage forcer 202 and a seat 204 providing for that a gap 206 is formed. A hydraulic actuator 208 can be used for making sure that the first stage forcer 202 is pushed towards the seat 204.

The second homogenizing device, placed downstream the first homogenizing device, comprises a second stage forcer 210 and a seat 212 providing for that a gap 214 is formed. A hydraulic actuator 216 can be used for making sure that the second stage forcer 210 is pushed towards the seat 212.

In two-stage homogenizers of today homogenization is taking place in the first stage. The second stage provides for that a constant and controlled back pressure to the first stage is supplied. Further, the second stage can be used for breaking up clusters formed directly after homogenisation.

In order to provide for that wear parts are replaced at the right time, that is not too early such that costs for spare parts increase unnecessary and not too late such that there is an equipment failure, pressure variations can be followed. More in detail, by measuring pressure on a product side, also referred to as product pressure, that is before the first stage forcer, and a hydraulic counter pressure, that is a pressure providing for that the first stage forcer is kept in place, a condition of the homogenizer can be determined.

It has been found that a condition of the homogenizing device can be determined by forming a ratio between the product pressure and the hydraulic counter pressure and comparing this ratio with a reference ratio formed by a reference product pressure and a reference hydraulic counter pressure. It has been found that if the ratio is within the range 85-115% of the reference ratio there is most likely no need to replace or refurbish the homogenizing device.

In order to determine a condition of the valves placed in the pump block, it has been found that a variance of the product pressure can be compared with a reference variance of the product pressure. Since reference data are from a homogenizing device working properly the ratio should be 1 or close to 1. According to tests made it has been found that if the ratio is above 2 it is usually a good idea to replace or refurbish the valves.

In some cases variances on the reference product pressure are very low with the effect that noise due to e.g. measurement errors has a greater effect. In order to provide for that these cases are handled in a good way as well a difference between the product pressure and the reference product pressure can be determined and taken into account.

Further, it has been found that product pressure and the hydraulic counter pressure vary depending on temperature. Thus, in order to take this into account a set of reference data for different temperatures can be used. In order to know which to choose one or several temperature sensors can be used. Another option, since the temperature is low when starting the homogenizer and continuously increases, is to estimate the temperature based on the running time since start up from latest stop.

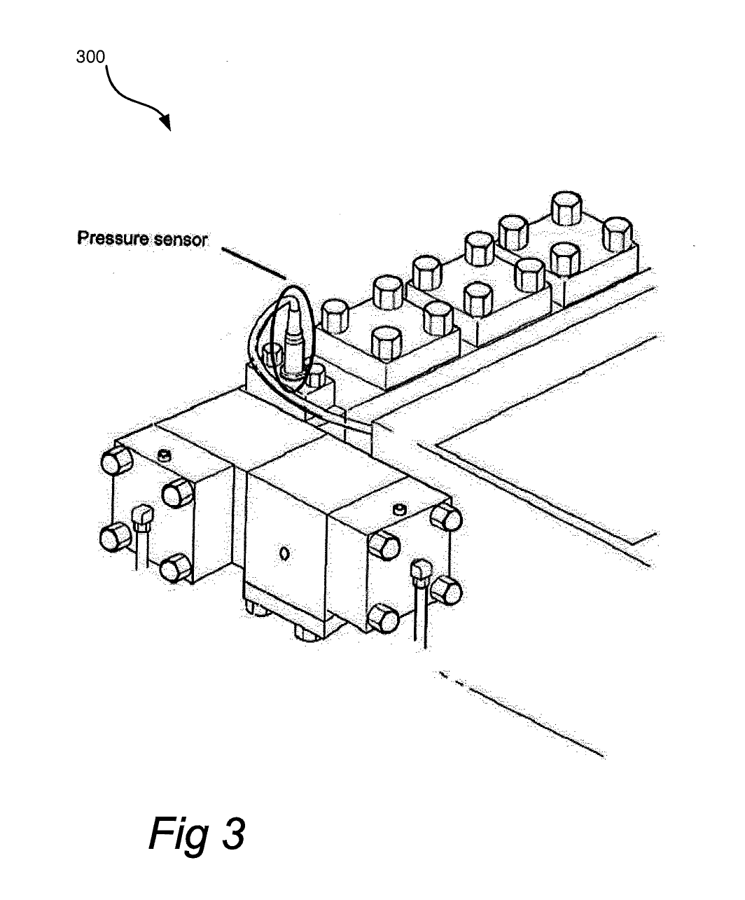

FIG. 3 illustrates a pump block, a first homogenizing device and a second homogenizing device. Further, a pressure sensor is placed in an area between the pump block and the first homogenizing device. The pressure sensor can be used for measuring the product pressure referred to above.

Since it has been found that turbulence is formed after the first homogenizing device when this is worn out, a sensor for measuring turbulence may be used as a complement to the pressure sensors, or alternatively on its own. In order to measure turbidity an ultrasound sensor may be used, making it possible to place this on the outside of the equipment, which of course is an advantage in terms of installation.

Sensors for measuring vibration may be applicable as well, but pressure sensors are more cost efficient and, due to the high pressures, more reliable.

Further, since the product pressure is formed by pistons, as illustrated in FIG. 1, the product pressure varies depending on where in the cycle the pistons are. In most cases, the pistons are linked to an eccentric shaft, or crankshaft, and valves are opened and closed in order to make sure that a product pressure is formed. Thus, when determining the product pressure the position of the eccentric shaft can be taken into account in order to know which valves that are open and which that are closed. With this information at hand the different valves can be monitored separately.

Apart from the product pressure in the first homogenizing device, the hydraulic counter pressure in the first homogenizing device can be measured. Further, in the second homogenizing device, placed downstream the first homogenizing device, a product pressure can be measured as well as a hydraulic counter pressure.

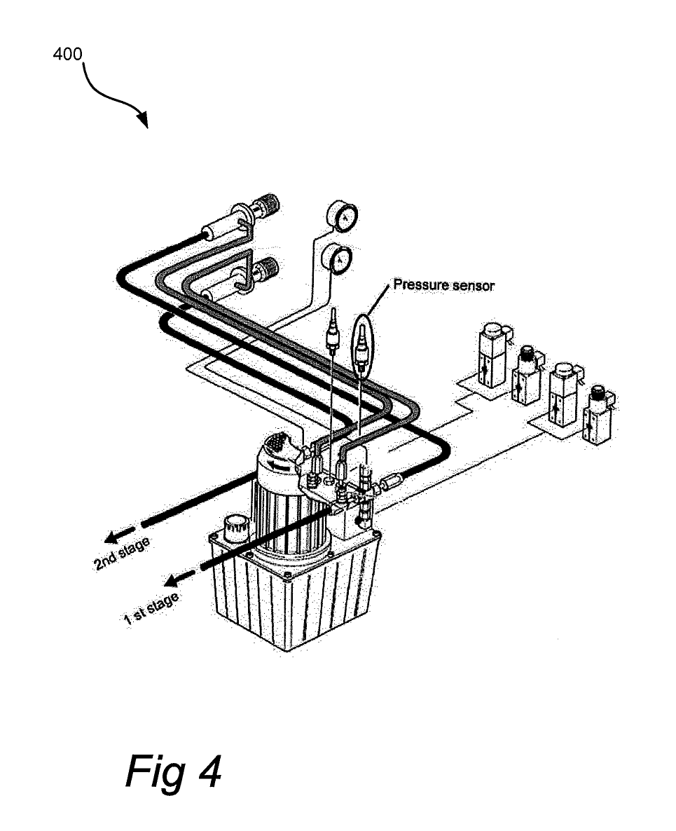

FIG. 4 illustrates a hydraulic pump used for forming the hydraulic counter pressure in both the first homogenizing device and the second homogenizing device. Alternatively, two hydraulic pumps can be used, one for the first homogenizing device and one for the second homogenizing device.

As illustrated, by using a pressure sensor the counter pressure can be measured.

The data handling apparatus, being the apparatus making the comparison of the pressure data and the reference pressure data, may be part of the homogenizer. Another option is to have it placed next to the homogenizer, but as a separate unit. Still an option is to have an off site solution, where data is sent from the homogenizer to a server placed elsewhere. The server may store reference data and/or do operations associated with the comparison and, optionally, also send out information about the condition of the homogenizer.

In order to make sure that appropriate reference data are used, e.g. reference product pressure data and reference counter pressure data, reference data can be shared among a number of homogenizers via the server. For instance, reference data for a particular machine can be uploaded to the server. The reference data can be compared to other similar homogenizers having similar conditions, e.g. running a similar product. If the reference data differ substantially from previously collected reference data from similar homogenizers an indication to review the reference data can be sent to the service operator or other person responsible for the operation of the homogenizer.

Another option with having reference data on a server is that there is a possibility to download the reference data to the homogenizer instead of collecting the reference data at the site. This will save time and reduce time needed for the set up. Further, if reference data do not exist for a specific configuration, but in different aspects similar configurations, it can be possible to extrapolate the reference data based on the existing reference data related to similar configurations.

The invention has mainly been described above with reference to a few embodiments. However, as is readily appreciated by a person skilled in the art, other embodiments than the ones disclosed above are equally possible within the scope of the invention, as defined by the appended patent claims.

1. A method for condition monitoring of a homogenizer, said method comprising
receiving first pressure data from a first pressure sensor, said first pressure data indicating a product pressure upstream a homogenizing device, and
comparing said first pressure data with a first pressure reference data.

2. The method according to claim 1, said method further comprising
receiving second pressure data from a second pressure sensor, said second pressure data indicating a counter pressure used for holding a forcer in said homogenizing device in position,
comparing said first pressure data and said second pressure data with a first pressure reference data and a second pressure reference data.

3. The method according to claim 2, wherein said second pressure data is related to a hydraulic pressure produced by a hydraulic pump.

4. The method according to claim 2, wherein said comparing of said first pressure data and said second pressure data with a first pressure reference data and a second pressure reference data, further comprises
determining a pressure ratio between said first pressure data and said second pressure data,
determining a deviation ratio between said pressure ratio and a pressure reference ratio, the pressure reference ratio being a ratio between said first pressure reference data and said second pressure reference data.

5. The method according to claim 4, further comprising sending a notification signal indicating non-optimal conditions if said deviation ratio is less than 0.85.

6. The method according to claim 4, further comprising sending a notification signal indicating non-optimal conditions if said deviation ratio is greater than 1.15.

7. The method according to claim 1, further comprising
receiving a third pressure data from a third pressure sensor, said third pressure data indicating an additional product pressure downstream of said homogenizing device and upstream of an additional homogenizing device,
wherein said comparing of said first pressure data with said first pressure reference data, further comprises comparing said third pressure data with a third pressure reference data.

8. The method according to claim 1, further comprising
receiving a fourth pressure data from a fourth pressure sensor, said fourth pressure data indicating a counter pressure used for holding an additional forcer in an additional homogenizing device in position, and
wherein said comparing of said first pressure data with said first pressure reference data, further comprises comparing said fourth pressure data with a fourth pressure reference data.

9. The method according to claim 1, further comprising
receiving an eccentric shaft position data from a position sensor, and
wherein said comparing of said first pressure data and said second pressure data with said first pressure reference data and said second pressure reference data, further comprises taking into account said eccentric shaft position in order to provide for that differences depending on the eccentric shaft position are compensated for.

10. The method according to claim 1, further comprising
receiving a running time data indicating running time since latest stop,
wherein said comparing of said first pressure data and said second pressure data with said first pressure reference data and said second pressure reference data, further comprises taking into account said running time data in order to provide for that differences depending on said running time since latest stop are compensated for.

11. The method according to claim 1, further comprising
receiving a temperature data indicating a temperature of said homogenizer,
wherein said comparing of said first pressure data with said first pressure reference data, further comprises taking into account said temperature data in order to provide for that differences depending on said temperature of said homogenizer are compensated for.

12. The method according to claim 1, wherein said step of comparing of said first pressure data with a first pressure reference data comprises
determining a variance for said first pressure data, and
comparing said variance for said first pressure data with a variance for said first pressure reference data.

13. A system for condition monitoring of a homogenizer, said system comprising
a first pressure sensor for capturing a first pressure data, said first pressure data indicating a product pressure upstream a homogenizing device, and
a data handling apparatus for comparing said first pressure data with a first pressure reference data.

14. The system according to claim 13, further comprising
a second pressure sensor for capturing a second pressure data, said second pressure data indicating a counter pressure used for holding a forcer in said homogenizing device in position, and
said data handling apparatus being configured to compare said first pressure data and said second pressure data with a first pressure reference data and said second pressure reference data.

15. The system according to claim 13, further comprising
a third pressure sensor for capturing a third pressure data indicating an additional product pressure downstream said homogenizing device and upstream an additional homogenizing device, and
said data handling apparatus being configured to compare said third pressure data with a third pressure reference data.

16. The system according to claim 13, further comprising
a fourth pressure sensor for capturing a fourth pressure data indicating a counter pressure used for holding an additional forcer in an additional homogenizing device in position, and
said data handling apparatus being configured to compare said third pressure data and said fourth pressure data with a third pressure reference data and a fourth pressure reference data.

17. The system according to claim 13, further comprising
a position sensor for determining an eccentric shaft position, and
said data handling apparatus being configured to take said eccentric shaft position into account when comparing said first pressure data with said first pressure reference data.

18. A computer program comprising computer program code adapted to perform claim 1 when said computer program is run on a computer.

19. A method for condition monitoring a homogenizer comprised of a first homogenizing device and a second homogenizing device, the second homogenizing device being positioned downstream of the first homogenizing device, the first homogenizing device being comprised of a seat, a forcer positioned relative to the seat so that a gap exists between the forcer and the seat through which product to be homogenized passes, and an actuator configured to push the forcer toward the seat, said method comprising:
determining product pressure upstream of the forcer of the first homogenizing device;
comparing the product pressure upstream of the forcer of the first homogenizing device with pressure reference data to obtain a comparison result; and
determining that replacement of a part of the first homogenizing device is necessary using the comparison result.

20. The method according to claim 19, the method further comprising:
receiving pressure data identifying a counter pressure that holds the forcer of the first homogenizing device in position; and
wherein the determination that replacement of a part of the first homogenizing device is necessary is made also using the pressure data.
